(19) United States
(12) Patent Application Publication
(10) Pub. No.: US 2004/0075693 A1
(43) Pub. Date: Apr. 22, 2004

(54) Compact method of navigating hierarchical menus on an electronic device having a small display screen

(76) Inventors: Timothy A. Moyer, Plano, TX (US); Alan G. Smith, Allen, TX (US)

Correspondence Address: TEXAS INSTRUMENTS INCORPORATED, P O BOX 655474, M/S 3999, DALLAS, TX, 75265

(21) Appl. No.: 10/274,754

(22) Filed: Oct. 21, 2002

(51) Int. Cl. G09G 5/00

(52) U.S. Cl. 345/810

(57) ABSTRACT

A compact menu structure for computing devices with a small display screen. The menu structure reduces the number of menu panels displayed on the screen while still providing the user with a visible representation of the menu structure. In an embodiment of the present invention, an application program on a handheld calculator or other small screen computer device provides a compact menu structure that has a navigation bar and a single submenu panel. The navigation bar displays the menu tree for the menu displayed in the submenu panel. The navigation bar may wrap to multiple line for deep menu structures. Other embodiments include a sliding bar in the menu sub-panel for sub-panels that have more items than will fit in the sub-panel.

### TECHNICAL FIELD OF THE INVENTION

This invention relates to electronic computing devices and software on those devices, and more particularly to a compact method of navigating hierarchical menus on an electronic device having a small display screen.

### BACKGROUND OF THE INVENTION

Software systems on many computer devices use a menu system with a pointer device to allow the user to select from a multitude of options to be executed by the computer. A popular menu structure is a cascading menu. The cascading menu typically starts with a menu bar at the top or bottom of the display screen that has icons or words that divide the menu bar for the top level of menu items. When one of these words or icons is selected with the pointer device, a first menu panel is shown with submenu items, which correspond to choice for the top level menu item. The first menu panel is usually shown above or below the menu bar. Subsequently, the user can chose a menu item from the first menu panel to display a second menu panel. The second menu panel is usually displayed next to the first panel. Likewise, other sublevels of menu can be displayed on the screen.

The popular cascading menu structure is cumbersome and more difficult to implement on small display screens such as those on handheld calculators, personal digital assistants, cell phones, and other handheld computer devices. Because of the limited size of the screen, multiple levels of menu are difficult to display on the screen in a manner that is helpful to the user. The small size of the display results in the menu panels being overlapped, making it difficult for the user to see the menu structure and making the screen display appear jumbled or disjoint when several levels are displayed. Further, the software to maintain the multiple overlapping panels is complicated and more prone to errors.

### SUMMARY OF THE INVENTION

The present invention provides a compact menu structure for small screen computing devices. The menu structure of the present invention is similar to the cascading menu structure most computer users are familiar with, but reduces the number of menu panels displayed on the screen while still providing the user with a visible representation of the menu structure. The technique is similar to the bread crumb approach to internet web page design, where a “bread crumb” link is left on each page to return to the previous page.

In an embodiment of the present invention, an application program on a handheld calculator or other small screen computer device provides a compact menu structure that has a navigation bar and a single submenu panel. The navigation bar displays the menu tree for the menu displayed in the submenu panel. The navigation bar may wrap to multiple lines for deep menu structures. Other embodiments include a sliding bar in the menu sub-panel for sub-panels that have more items than will fit in the sub-panel.

An embodiment of the present invention is an application program on a handheld calculator or other computer. Other embodiments of the invention are directed to a user interface on a calculator or other handheld computing device.

### BRIEF DESCRIPTION OF THE DRAWINGS

FIG. 1 illustrates a hand-held computer device incorporating the features of an embodiment of the present invention.

FIGS. 2a-e illustrate a sequence of screen displays according to an embodiment of the present invention.

FIG. 3 illustrates a scroll bar in a submenu panel according to an embodiment of the present invention.

### DETAILED DESCRIPTION OF THE INVENTION

An embodiment of the present invention provides a compact menu structure for a handheld computing device that is similar to the cascading menu structure, but reduces the number of menu panels displayed on the screen while still providing a the user with a visible representation of the menu structure.

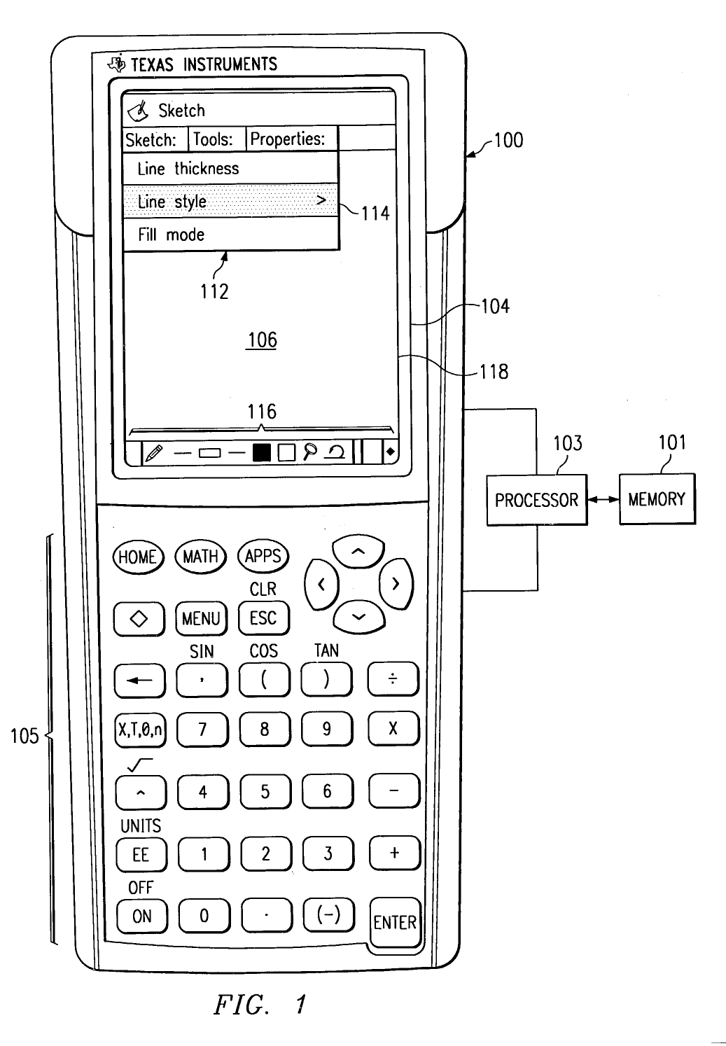

FIG. 1 illustrates a computer or hand held computing device 100 that incorporates features of the present invention. The device executes software described herein stored in memory 101 on the processor 103. The device has a display screen 102 having a display area 104. In this embodiment, the display is a touch sensitive display that uses a stylus for input (not shown) as well as the keyboard 105. The display screen 102 illustrates an embodiment of the present invention as described below.

The display screen 102 includes a header button bar 106 that shows the current tool (in this case the calculator tool “Sketch” screen). The header button bar may display several icons to bring up different calculator tools. The navigation bar 112, and submenu panel 114 are described further below. The display area 104 also has a bottom button bar 116 that has options for the currently selected mode.

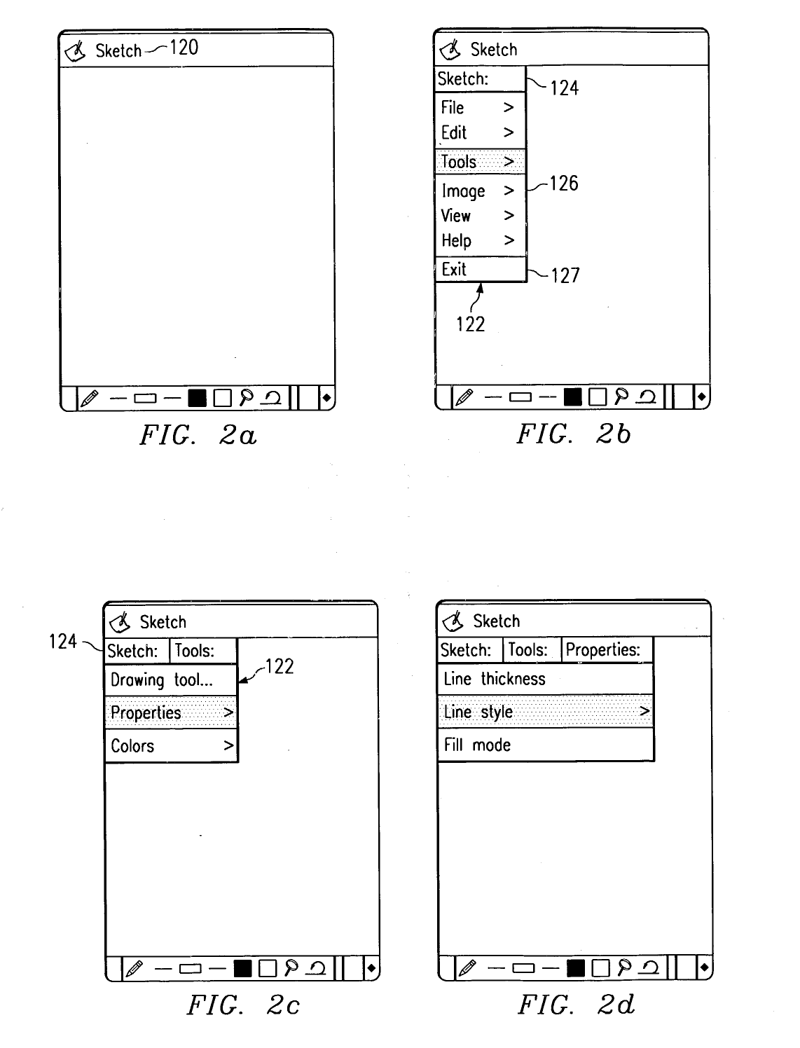

FIGS. 2a-d represent the display screen of the calculator shown in FIG. 1 to illustrate embodiments of the present invention. When the user activates the sketch mode of the calculator shown in FIG. 1, the screen will default to a blank display screen as shown in FIG. 2a. The sketch mode has a modified top tool bar 120. The top tool bar shows the current tool operating on the computer device. In the displayed embodiment of the present invention, the sketch functions are activated by selecting the top tool bar 120. FIG. 2b shows the first menu panel 122 displayed upon activating the top tool bar. The first menu panel includes a navigation bar 124, a set of menu items 126 (functions associated with the sketch function) including a tool “exit” 127 option.

The navigation bar 124 lists in sequence each of the levels of menu that was navigated to arrive at the menu panel currently displayed. Thus the navigation bar shows the menu structure hierarchy for the current menu panel. As will be shown, each level of the menu structure in the navigation bar is a separate button that can be selected to move up the menu structure. In FIG. 2b the menu structure for the current panel 122 is the top level menu for the sketch function, the top level menu sketch. Items 126 in the menu panel 122 that include a submenu are indicated with the “>” sign, a common practice.

In FIG. 2b the cursor location is indicated by the reverse image over the menu item “Tools.” Selecting the “Tools” item on the submenu will display the next submenu panel as shown in FIG. 2c. As shown in FIG. 2c, the navigation bar 124 indicates the current menu panel 122 is “Sketch: Tools:”. Each level of the menu structure on the navigation bar is a separate navigable button (Sketch, and Tools) and is shown in the order of the hierarchy of the current menu panel 122.

In FIG. 2c the cursor location is indicated by the reverse image over the menu item “Properties.” Selecting the “Properties” item on the submenu will display the next submenu panel as shown in FIG. 2d. Similar to the previous screen, the navigation bar 124 indicates the current menu panel 122 is “Sketch: Tools: Properties:.” Again, selecting the highlighted menu item, “Line Style” will result in the screen display shown in FIG. 2e. The navigation bar 124 continues to show the menu structure as describe above. However, since the screen width is not sufficient to display the full menu structure on the one line of the navigation bar, the navigation bar wraps to a second line as shown.

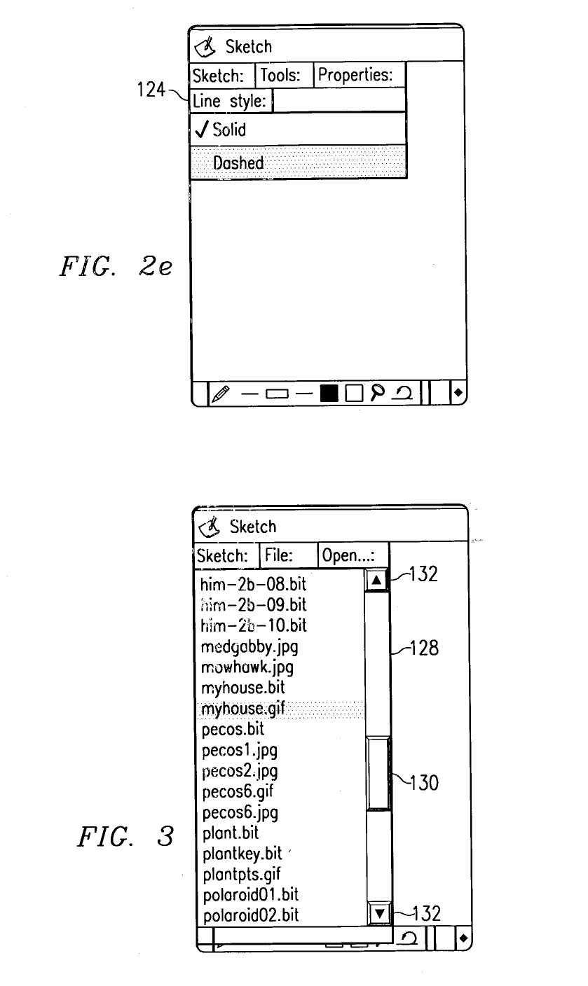

Another feature of the present invention is shown in FIG. 3. Where the menu items in a menu are too many to fit in a sub-panel on the screen, a menu scroll bar 128 is displayed within the menu. The menu scroll bar has a drag button 130 for moving the displayed menu items up or down. The menu scroll bar also has up and down buttons 132 for moving the displayed menu items up or down one item at a time.

### Other Embodiments

Although the present invention has been described in detail, it should be understood that various changes, substitutions, and alterations could be made hereto without departing from the spirit and scope of the invention as defined by the appended claims.

The features that are the subject of the present invention could be incorporated into other into other computer based teaching tools and computers. Similarly, other embodiments include the same user interface functionality in a ROM software application package that is executed on a computer, graphing calculator, PDA, cellphone or other handheld device.

What is claimed is:

1. A software program stored on a computer media for a computer device which provides a user interface comprising:
a display area;
a menu panel in the display area having a menu with a selection of menu items, and
a navigation bar adjacent to the menu area
wherein the navigation bar includes a hierarchy indication of the location of the menu within a hierarchy of menus in the user interface.

2. The software program of claim 1, wherein the navigation bar is a sequence of buttons for each level of the menu hierarchy and each button is navigable to return the menu to that level in the hierarchy corresponding to the button selected.

3. The software program of claim 1, wherein a single menu panel is shown in the display area.

4. The software program of claim 1, wherein the navigation bar wraps to additional lines when the indication of the menus is longer than the available width of the display area.

5. The software program of claim 1, further comprising a menu bar to scroll items in the menu panel for menus having more items than will fit in the display area.

6. A handheld computing device comprising:
a display screen;
an input device for operating the computing device and entering user responses;
a processor for executing programming that provides a user interface to a graphing software application wherein the user interface further comprises:
a display area on the display screen;
a menu panel in the display area having a menu with a selection of menu items, and
a navigation bar adjacent to the menu area
wherein the navigation bar includes a hierarchy indication of the location of the menu within a hierarchy of menus in the user interface

7. The handheld computing device of claim 6, wherein the navigation bar is a sequence of buttons for each level of the menu hierarchy and each button is navigable to return the menu to that level in the hierarchy corresponding to the button selected

8. The handheld computing device of claim 6, wherein a single menu panel is shown in the display area.

9. The handheld computing device of claim 6, wherein the navigation bar wraps to additional lines when the indication of the menus is longer than the available width of the display area.

10. The handheld computing device of claim 6, further comprising a menu bar to scroll items in the menu panel for menus having more items than will fit in the display area.

11. A user interface for a computer device comprising:
a display area;
a menu panel in the display area having a menu with a selection of menu items, and
a navigation bar adjacent to the menu area
wherein the navigation bar includes a hierarchy indication of the location of the menu within a hierarchy of menus in the user interface.

12. The user interface of claim 11, wherein the navigation bar is a sequence of buttons for each level of the menu hierarchy and each button is navigable to return the menu to that level in the hierarchy corresponding to the button selected.

13. The user interface of claim 11, wherein a single menu panel is shown in the display area.

14. The user interface of claim 11, wherein the navigation bar wraps to additional lines when the indication of the menus is longer than the available width of the display area.

15. The user interface of claim 11, further comprising a menu bar to scroll items in the menu panel for menus having more items than will fit in the display area.
